(19) United States
(12) Patent Application Publication
(10) Pub. No.: US 2005/0200262 A1
(43) Pub. Date: Sep. 15, 2005

(54) Lamp with metal grid radiator for heat dissipation

(76) Inventor: Jiahn-Chang Wu, Hsin-Chu (TW)

Correspondence Address: Hung Chang Lin, 8 Schindler Ct., Silver Spring, MD, 20903, US

(21) Appl. No.: 10/800,207

(22) Filed: Mar. 15, 2004

(51) Int. Cl. F21V 9/00

(52) U.S. Cl. 313/349

(57) ABSTRACT

A metal grid is placed in the open end of a cup-shaped light bulb as a radiator to dissipate the heat generated from the light emitting device. One or more light emitting devices can be placed on the inner side surface of the metal grid, and the light emitted from the light emitting devices is reflected by the inner surface of the cup and transmitted through the windows in the metal grid. The horizontal plates of the metal grid and the vertical walls of the grid can be insulated from each other to serve as electrodes for the light emitting device. The cup can be back-filled with glass or other transparent polymer composite to prevent dust from entering the cup. Alternatively, a single light emitting device is place near the bottom of the cup

### BACKGROUND OF THE INVENTION

1. Field of the Invention

This invention relates to lamps, particularly to a radiator for lamps for more effective heat removal.

2. Brief Description of Related Art

FIG. 1 shows a prior art lamp. Two light emitting devices 11, 12 are mounted inside a cup 17. Each light emitting device has a bottom electrode anchored in the cup which is connected to a lead 14a, and a top electrode wire-bonded to leads 14b, 14c. The light emitting devices are sealed in a glue 16 for protection and reliability.

This prior art structure has the drawback that the heat generated in the light emitting devices cannot be removed efficiently. For increased light emission, the voltage applied to the light emitting devices must be increased, generating more heat, which may cause permanent damage to the light emitting device. This kind of structure has limited heat dissipating area and hence limits the light intensity of the lamp.

### SUMMARY OF THE INVENTION

An object of this invention is to increase the light intensity of a lamp. Another object of this invention is to remove the heat generated in the lamp.

These objects are achieved by providing a heat radiator inside the lamp for dissipating the heat generated by the light emitting device. The radiator is a metal grid placed in the open end of the cup from which light is transmitted. The light from the light emitting device is transmitted through the windows of the metal grid structure of the radiator.

### BRIEF DESCRIPTION OF THE DRAWINGS

FIG. 1 shows a prior art lamp structure.

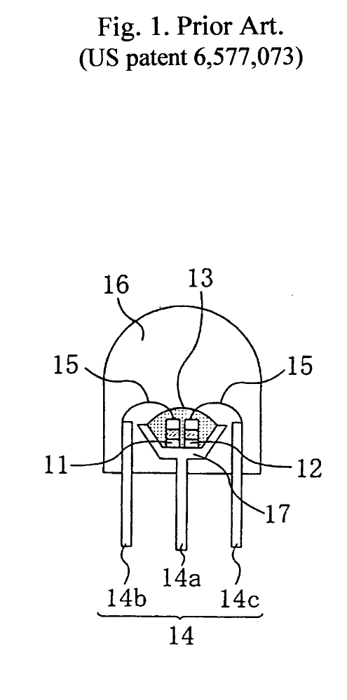

FIG. 2 shows the basic structure of the present invention having a metal grid radiator having two light emitting devices.

FIG. 3 shows a second embodiment of the present invention having a single light emitting device

FIG. 4 shows a third embodiment of the present invention having the grid back-filled with glass.

### DETAILED DESCRIPTION OF THE INVENTION

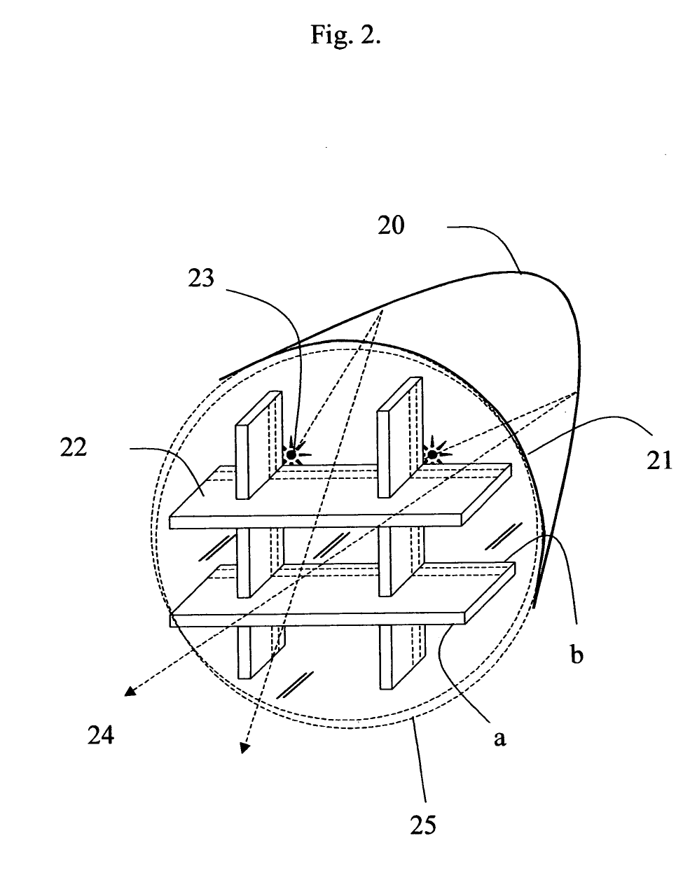

FIG. 2 shows the basic structure of the present invention. Two light emitting devices 23 and a metal grid radiator 22 are housed in a cup-shaped light bulb 20. The metal grid radiator 22 is placed toward the open end 21 of the cup 20 from which light is projected. The metal grid radiator 22 has stacked parallel horizontal plates separated by vertical walls, serving as a radiator 22 to dissipate heat generated in the light emitting devices 23. Each plate or wall of the metal grid 22 has an outer side “a” facing the open end 21 and an opposite inner side “b”. At least one light emitting devices 23 are placed on the inner side “b” surface. The cross points are the best place to place the light emitting device 23 for electrical coupling, but the area between the cross points is not excluded for placing the light emitting device 23. At least one light emitting device 23 is used. However, two light emitting devices 23 are exampled in FIG. 2. The light emitted from the light emitting devices 23 is reflected from the inner wall of the cup 20 and projected through the windows of the metal grid radiator 22 as light rays 24. Since the metal grid structure 22 has a great deal of exposed surfaces, the metal grid structure 22 serves as an efficient radiator to cool down the light emitting device 23.

If the horizontal plates and/or the vertical walls serve as leads for the light emitting devices 23, the horizontal plates and the vertical walls can be isolated from each other with insulators (not shown) at the cross-points. These leads can be wire-bonded or coupled by any known practice to the horizontal plates or the vertical walls respectively.

The window of the metal grid 22 can be back-filled with glass or some polymer transparent composite to prevent any dust from entering the cup 20. The dotted line on the metal grid 22 and dotted circle 25 show the area the area to be filled with transparent material 25. Furthermore, the “a” surfaces of the metal grid can be protruded outside the open end to further improve heat dissipation.

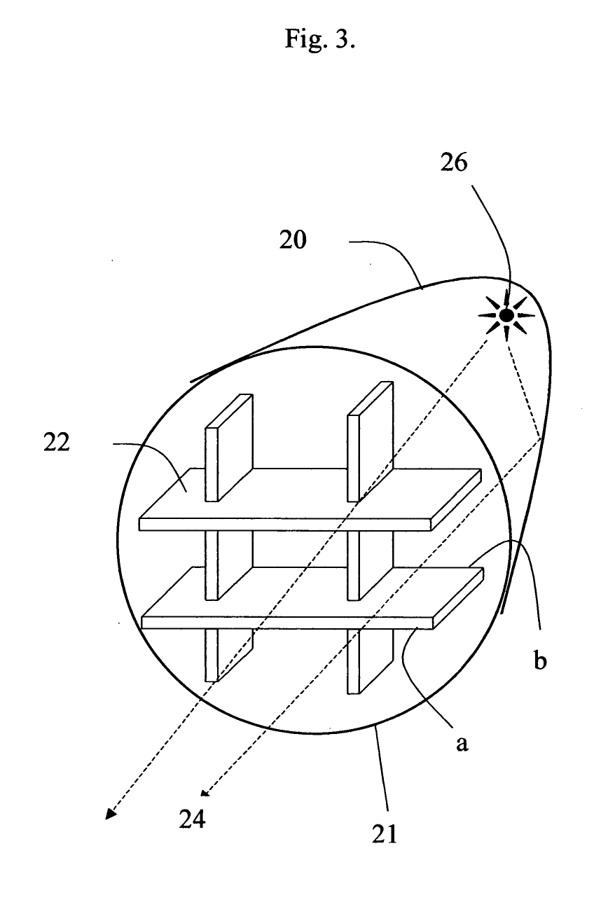

FIG. 3 shows a second embodiment of the invention. In this invention, the metal grid radiator 22 with open grid, i.e. without any back-filled transparent material in the grid is placed toward the open end 21 of the cup 20, with outer surfaces “a” and inner surfaces “b”. The light emitting device 26 is placed at the bottom of the cup such as the focal point. The light emitted from the light emitting device 26 can be transmitted through the windows of the metal grid either directly or reflected from the inner wall of the cup as emitting rays 24.

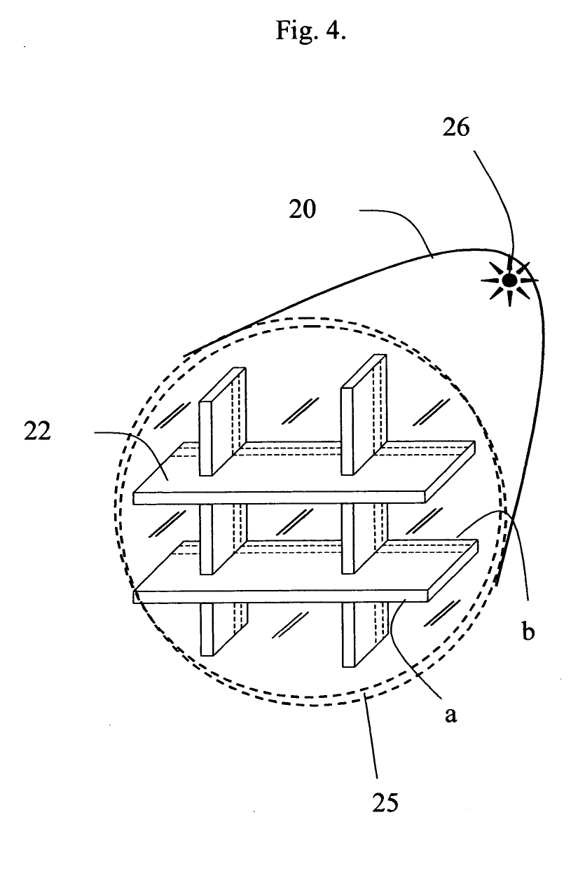

FIG. 4 shows a third embodiment of the invention. The structure is similar to that in FIG. 3 with reference numbers denoting corresponding parts. The windows of the metal grid 22 is backfilled with glass or polymer transparent composite to prevent any dust from entering the cup.

While the preferred embodiments of the invention have been described, it will be apparent to those skilled in the art that various modifications may be made in the embodiments without departing from the spirit of the present invention. Such modifications are all within the scope of the present invention.

1. A light bulb, comprising:
at least one light emitting device;
a cup in which said light emitting device is housed;
a metal grid placed in the open end of said cup, serving as a radiator to dissipate the heat generated from said light emitting device, and as windows for transmission of light emitted from said light emitting device.

2. The light bulb as described in claim 1, wherein said metal grid comprises a matrix of parallel horizontal plates and parallel vertical walls, each having an outer surface facing said open end and an inner surface facing said light emitting device.

3. The light bulb as described in claim 2, wherein said at least one light emitting device is placed on said inner surface of said metal grid.

4. The light bulb as described in claim 2, wherein each one of said light emitting device has two electrodes connected to one of said parallel horizontal plates and one of said parallel vertical walls respectively, and said horizontal plates and said vertical walls are insulated from each other.

5. The light bulb as described in claim 1, wherein said cup is back-filled with transparent material selected from the group consisting of glass and transparent polymer composite.

6. The light bulb as described in claim 1, wherein one said light emitting device is placed at the bottom of the cup.

7. The light bulb as described in claim 5, wherein said metal grid is partially protruded outside back-filled material for increasing heat removal.
